(19) United States
(12) Patent Application Publication
(10) Pub. No.: US 2021/0137770 A1
(43) Pub. Date: May 13, 2021

(54) MOVEMENT AID

(71) Applicant: KSV FINLAND LLC, Wichita, KS (US)

(72) Inventors: Klaus VILJANMAA, Wichita, KS (US); Juha ALITALO, Kankaanpää (FI); Jarmo RAUKOLA, Veneskoski (FI); Tero-Pekka NEVALA, Tampere (FI)

(73) Assignee: KSV FINLAND LLC, Wichita, KS (US)

(21) Appl. No.: 17/045,814

(22) PCT Filed: Feb. 21, 2019
(86) PCT No.: PCT/FI2019/050136

§ 371 Date: Oct. 7, 2020

(30) Foreign Application Priority Data
Apr. 9, 2018 (FI) 20185330

(51) Int. Cl. A61H 3/04

(52) U.S. Cl. CPC A61H 3/04; A61H 2003/006; A61H 2003/046

(57) ABSTRACT

A movement aid, includes a frame with elbow rests on its opposite sides and wheels at its corners. The frame further includes at least elements for adjusting a height of the elbow rests with respect to a support surface, for adjusting a mutual distance thereof in a transverse direction with respect to a longitudinal direction of the frame, and/or for adjusting a tilt angle thereof. The front wheels and/or the rear wheels are adapted to be capable of swiveling around vertical axes and/or to be locked/lockable in the longitudinal direction of the frame. In addition, the frame is adapted to enable a center of gravity of the movement aid using person to remain within a space defined by the wheels. The frame consists of two frame members of which the first frame member is provided with front wheels and the second frame member with rear wheels.

The invention relates to a movement aid according to the preamble of an independent claim directed there-to.

U.S. Pat. No. 7,866,677 discloses a rollator, including a frame with elbow rests on its opposite sides and wheels at its corners. The discussed apparatus is further provided with means for adjusting the elbow rests' height with respect to a support surface and for adjusting the mutual distance thereof in a direction transverse to a longitudinal direction of the frame. The rollator has its front and rear wheels adapted to be pivotable around vertical axes, such that the front wheels are freely swiveling and the rear wheels are “automatically” oriented by a swivel arm mechanism in a longitudinal direction of the frame as the frame width is changed.

In this cited solution, it is possible to vary the distance of elbow rests from each other in transverse direction by rotating frame members included in the frame relative to each other around a vertical axis, the rollator's wheels moving at the same time relative to each other, which undermines seriously the rollator's stability by reducing a transverse distance between the wheels present on opposite sides. Another drawback in this type of solution is that, the same way as when using conventional rollators, the center of gravity of a person using the rollator is located on a posterior side of the rollator, which is why the rollator user easily develops a slouched posture. In addition, because of rear wheels becoming oriented in a traveling direction of the rollator, it is particularly in confined spaces that the rollator does not have a satisfactory usability.

U.S. Pat. No. 9,289,347 further discloses a mobility device for the similar purpose, including a base frame having a fixed structure when considered in transverse direction and being provided with elbow rests and front wheels swivelable around vertical axes. Connected to upright columns on opposite sides of the base frame are structural members, which are movable from use position to standby position and have connected thereto the longitudinally oriented rear wheels of the mobility device. The mobility device is further provided with elements for adjusting the elbow rests' height, which are implemented with extension rods to be set in the frame's upright columns at adjustable heights. The mobility device also includes elements for adjusting a tilt angle of the elbow rests, which are implemented with elbow rests being rotatable on the extension rods in vertical plane.

With respect to conventional rollator designs, this cited solution provides a benefit in the sense that its base frame is adapted to enable the center of gravity of a person using the mobility device to remain within a space defined by the wheels, which improves usability of the mobility device by also assisting a person using the mobility device to maintain a posture which is better than what is obtained when using a conventional rollator. However, the cited solution does not enable the elbow rests to be adjusted in transverse direction individually for a mobility device user. The mobility device is further provided with a seat member, whose location on an anterior side of the base frame is nevertheless unfavorable by restricting the leg movement of a person using the mobility device, as well as, on the other hand, by being positioned in what can be considered a wrong way with respect to control devices for the elbow rests, e.g. for adjusting the height or tilt angle of the elbow rests, while sitting on the seat.

It is an objective for a movement aid according to the present invention to provide a decisive improvement regarding the foregoing problems and to thereby raise substantially the existing state of the art. In order to attain this objective, the movement aid according to the invention is principally characterized by what is presented in the characterizing clause of an independent claim directed thereto.

As the most significant benefits gained by a movement aid of the invention should be mentioned the simplicity of its construction and operation, as well as its versatile functionality to enable its safe use also in tight spaces as the distances between wheels remain constant regardless of the size of a person using the movement aid.

It is easy for a person using the movement aid to retain “automatically” an optimal position relative to the movement aid and to maintain a good posture by virtue of versatile adjustment possibilities of the movement aid, whereby the size, movements, physical condition of a person using the movement aid, or various adjustments of the movement aid, do not impair support for a person while he/she is using the movement aid. Neither is there any need for a person using the movement aid to worry about his/her own support when using the movement aid, or e.g. when sitting on a seat included therein, as he/she is adjusting the movement aid.

In addition, as the movement aid further enables a person using the same to use his/her hands more freely, it is possible to conduct the use of e.g. doors, a telephone or an elevator, or the handling of various articles, without problems and without impairing support for the person. It is further possible to adjust both height and inclination of the armrests in such a way that the person's support also in this respect remains optimal both when using and when adjusting the movement aid.

A particularly important feature in the present invention is moreover the fact that it is possible to adjust the distance between the movement aid's armrests in a completely individual manner without changing a mutual distance of the wheels or changing an adjusted inclination of the armrests.

Further, with all the movement aid's wheels being preferably freely swiveling around vertical axes, the optimal functionality and agility of the movement aid becomes possible especially in tight spaces, in addition to which, operating in various situations becomes remarkably easier. Therefore, by virtue of a movement aid of the invention it is also possible to enhance the body control, rehabilitation and fitness maintenance of a person using the same.

Other preferred embodiments for a movement aid of the invention are presented in dependent claims directed thereto.

The invention will now be described in detail with reference to the accompanying drawings, in which

FIG. 1 shows in a side view one preferred movement of the invention in a usage situation,

FIG. 2 shows a movement aid of the invention in a view from above,

FIGS. 3a and 3b show a movement aid of the invention in a view from the front with its elbow rests in two positions of use different in terms of a mutual distance,

FIGS. 4a and 4b show a movement aid of the invention in a view from the front with its seat in a standby and use position,

FIGS. 5a and 5b show a movement aid of the invention in a side view with its seat in a standby position and swiveled to a seat-forming position, and

FIG. 6 shows a movement aid of the invention in a folded condition.

The invention relates to a movement aid, including a frame 1 with elbow rests 2 on its opposite sides and wheels 3a, 3b at its corners. The frame further includes at least elements 4a, 4b and/or 4c for adjusting a height h of the elbow rests with respect to a support surface, for adjusting a mutual distance thereof in a transverse direction p with respect to a longitudinal direction s of the frame, and/or for adjusting a tilt angle a thereof. The front wheels 3a and/or the rear wheels 3b are adapted to be capable of swiveling w around vertical axes and/or to be locked/lockable in the longitudinal direction s of the frame. The frame is further adapted to enable a center of gravity PP of the movement aid using person to be retained, on a principle apparent from FIG. 2, within a space A defined by the wheels 3a, 3b. The frame 1 consists, in reference e.g. to FIGS. 1, 5a, 5b and 6, of two frame members 1a, 1b of which the first frame member 1a is provided with front wheels 2a and the second frame member 1b with rear wheels 3b. In addition, the elements 4b for adjusting a mutual distance L of the elbow rests 2 in the transverse direction p with respect to the frame's longitudinal direction s are designed without changing a total width TW of the frame 1, said elements thus comprising swivel arms 4b1, included in the first frame member 1a, rotatable w around vertical axes and lockable F1 in a rotational position desired therefor. FIGS. 3a and 3b display a movement aid with its elbow rests 2 in two L1, L2 usage positions different in terms of a mutual distance thereof.

In a preferred embodiment for a movement aid of the invention, the elements 4a for adjusting the height h of the elbow rests 2 with respect to a support surface comprise, in reference e.g. to FIGS. 1, 5a, 5b and 6, adjustment arms 4a1, which are connected to the swivel arms 4b1 to be movable z in vertical direction and to be lockable F2 thereto at a height position desired for the same, and to the engagement with which the elbow rests 2 are connected.

In a further preferred embodiment for a movement aid of the invention, the locking F2 of its adjustment arms 4a1 to the swivel arms 4b1 at a height position desired therefor is carried out on a quick release principle, such as, as apparent e.g. from FIGS. 3a, 3b, with a mutual spring-loaded slot-locking pin arrangement or the like of said members.

In a further preferred embodiment for a movement aid of the invention, its elements 4c for adjusting the tilt angle a of the elbow rests 2 comprise, in reference e.g. to FIGS. 1, 5a and 5b, rotating mechanisms 3c1 between the elbow rests and the adjustment arms 4a1 for rotating t the elbow rests in a vertical plane and for locking F3 the same in a tilt position desired therefor. The locking arrangements F1 and F3 are preferably carried out by means of quick release skewers commonly used in bicycles.

In a further preferred embodiment for a movement aid of the invention, the first and second frame members 1a, 1b comprise, in reference e.g. to FIGS. 1, 5a, 5b and 6, when viewed in lateral direction, tube or rod members, rotatable relative to each other in vertical plane by means of an articulation system 5, such as a folding hinge or the like, and provided at bottom ends thereof with wheels 3a, 3b, for folding the movement aid to its standby position and for unfolding the same to its use position.

In a further preferred embodiment for a movement aid of the invention, all of its wheels 3a, 3b are adapted to be swivelable w around vertical axes, which enables an optimal agility for the movement aid even in tight spaces, as well as convenient access for a person using the same e.g. to an elevator operating panel, etc.

In a further preferred embodiment for a movement aid of the invention, the second frame member 1b comprises, as presented in FIGS. 1, 4a, 4b, 5a and 5b, seat members 6 capable of being locked in a standby position thereof to an upright position in longitudinal s planes of the movement aid and capable of rotating v to a use position thereof around longitudinal s axes of rotation.

In a further preferred embodiment for a movement aid of the invention, the wheels 3a, 3b have braking mechanisms 7 thereof adapted to be operated by moving two or more piece structural elements 2a, 2b of the elbow rests 2 relative to each other, in which context it is also naturally possible to make use of a handle element 2c as presented e.g. in FIG. 2 and operable on a joystick principle.

In a further preferred embodiment for a movement aid of the invention, its rotating, swiveling, tilting, locking, adjusting and/or braking mechanisms are adapted to work by means of mechanically, pneumatically and/or hydraulically operated actuators, enabling the adaptation of mechanical and/or hydraulic transmissions to proceed at least partially inside the frame.

In a further preferred embodiment for a movement aid of the invention, its rotating, swiveling, tilting, locking, adjusting and/or braking mechanisms are adapted to work by means of wirelessly operated radio-frequency actuators.

It is obvious that the invention is not limited to the foregoing or above-described embodiments but can be adapted within the scope of its basic inventive concept to have a multitude of variations, depending on a frame material used for the movement aid, which can be e.g. wood or bamboo, or may comprise a pipe section made of e.g. aluminum, steel or a composite material such as carbon fiber, etc. It is further obvious that the quick release skewers used in locking systems, as set forth in the drawings, can also be replaced by other types of locking arrangements. Respectively, it is possible that e.g. the braking mechanisms be implemented e.g. a drum, disc, caliper brake principle by making use of e.g. mechanical and/or hydraulic transmission or by utilizing wirelessly operated radio-frequency controllers and actuators.

1. A movement aid, including a frame with elbow rests on its opposite sides and wheels at its corners, the frame further including at least elements for adjusting a height of the elbow rests with respect to a support surface, for adjusting a mutual distance thereof in a transverse direction with respect to a longitudinal direction of the frame, and for adjusting a tilt angle thereof, whereby the front wheels and/or the rear wheels are adapted to be capable of swiveling around vertical axes and/or to be locked/lockable in the longitudinal direction of the frame, and whereby the frame is adapted to enable a center of gravity of the movement aid using person to remain within a space defined by the wheels, characterized in that the frame consists of two frame members of which the first frame member is provided with front wheels and the second frame member with rear wheels, and whereby the elements for adjusting a mutual distance of the elbow rests in the transverse direction with respect to the frame's longitudinal direction are designed without changing a total width of the frame, said elements thus comprising swivel arms, included in the first frame member, rotatable around vertical axes and lockable in a rotational position desired therefor.

2. A movement aid according to claim 1, characterized in that the elements for adjusting the height of the elbow rests with respect to a support surface comprise adjustment arms, which are connected to the swivel arms to be movable in vertical direction and to be lockable thereto at a height position desired for the same, and to the engagement with which the elbow rests are connected.

3. A movement aid according to claim 2, characterized in that the locking of the adjustment arms to the swivel arms at a height position desired therefor is carried out on a quick release principle, such as with a mutual spring-loaded slot-locking pin arrangement or the like of said members.

4. A movement aid according to claim 1, characterized in that the elements for adjusting the tilt angle of the elbow rests comprise rotating mechanisms between the elbow rests and the adjustment arms for rotating the elbow rests in a vertical plane and for locking the same in a tilt position desired therefor.

5. A movement aid according to claim 1, characterized in that the first and second frame members comprise, when viewed in lateral direction, tube or rod members, rotatable relative to each other in vertical plane by means of an articulation system 5, such as a folding hinge or the like, and provided at bottom ends thereof with wheels, for folding the movement aid to its standby position and for unfolding the same to its use position.

6. A movement aid according to claim 1, characterized in that all of its wheels are adapted to be swivelable around vertical axes.

7. A movement aid according to claim 1, characterized in that the second frame member comprises seat members capable of being locked in a standby position thereof to an upright position in longitudinal planes of the movement aid and capable of rotating to a use position thereof around longitudinal axes of rotation.

8. A movement aid according to claim 1, characterized in that the wheels have braking mechanisms thereof adapted to be operated by moving two or more piece structural elements of the elbow rests relative to each other.

9. A movement aid according to claim 1, characterized in that its rotating, swiveling, tilting, locking, adjusting and/or braking mechanisms are adapted to work by means of mechanically or hydraulically operated actuators.

10. A movement aid according to claim 1, characterized in that its rotating, swiveling, tilting, locking, adjusting and/or braking mechanisms are adapted to work by means of wirelessly operated radio-frequency actuators.
